(19) United States
(12) Patent Application Publication
(10) Pub. No.: US 2009/0011259 A1
(43) Pub. Date: Jan. 8, 2009

(54) SHELL OF ELECTRONIC DEVICE

(75) Inventors: CHE-YUAN HSU, Shindian (TW); KEN-HOLM HANSEN, Faarevejle (DK); YOU-XUN LU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); Sutech Trading Limited, Tortola (VG)

(21) Appl. No.: 11/947,089

(22) Filed: Nov. 29, 2007

(30) Foreign Application Priority Data
Jul. 4, 2007 (CN) 200710076376.0

(51) Int. Cl. B32B 15/08

(52) U.S. Cl. 428/457

(57) ABSTRACT

A shell (100) of an electronic device is provided. The shell includes a base body (10) and a color-changing layer (20). The color-changing layer is formed on a surface of the base body and configured to change its color thereof according to changes of temperature thereof.

### BACKGROUND OF THE INVENTION

1. Field of the Invention

The present invention relates to shells of electronic devices, and particularly to a shell of an electronic device that can change color thereof under a variety of environments.

2. Description of Related Art

Nowadays, with the mass variety of electronic devices distributed out on the market, consumers focus more and more on the appearance of an electronic device. The electronic device contains a consumer electronic device (e.g., a MP3 player), a communicating electronic device (e.g., a mobile phone), and etc. Often times, the popularity of such electronic devices is rated by its appearances.

Color of a shell of a typical electronic device cannot be changed once manufactured. After a certain period of usage, user might get bored with the color of the shell.

What is needed is a shell of an electronic device that can overcome the above-mentioned shortcomings.

### SUMMARY

In one aspect, a shell of an electronic device is provided. The shell includes a base body and a color-changing layer. The color-changing layer is formed on a surface of the base body and configured to change color thereof according to changes of temperature thereof.

These and other aspects of the present invention will become more apparent from the following detailed description of at least one preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present shell of an electronic device can be better understood with reference to the following drawings. These drawings are not necessarily drawn to scale, the emphasis instead being placed upon clearly illustrating the principles of the present shell of an electronic device. Moreover, in the drawings like reference numerals designate corresponding parts throughout the several views. Wherever possible, the same reference numbers are used throughout the drawings to refer to the same or like elements of an embodiment, and wherein:

FIG. 1 is an isometric view of a shell of an electronic device in accordance with a present embodiment; and

FIG. 2 is a cross-sectional view of the shell taken along a line 11 shown in FIG. 1.

### DETAILED DESCRIPTION OF THE EMBODIMENTS

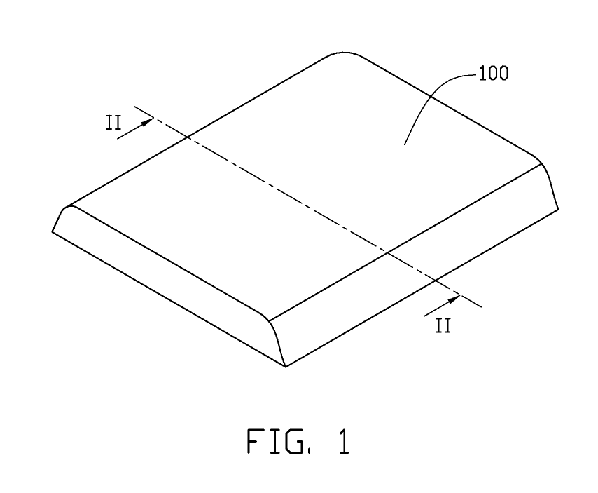

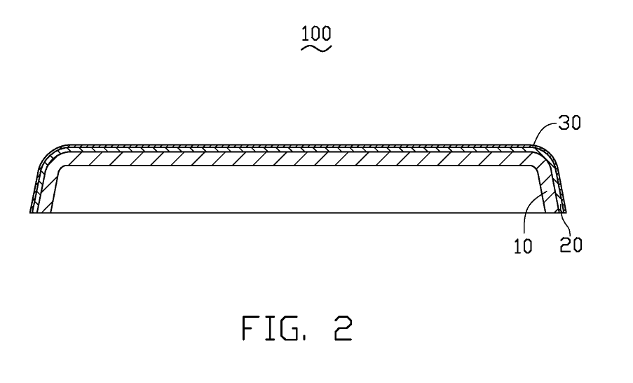

The present shell of an electronic device is described here in conjunction with the accompanying drawings in FIGS. 1 and 2. The shell is suitable for electronic device such as a consumer electronic device (e.g., a MP3 player), a communicating electronic device (e.g., a mobile phone), or the like.

Referring now to FIGS. 1 and 2, the shell 100 used in an electronic device includes a base body 10, a color-changing layer 20, and a protective layer 30.

The base body 10 can be made of plastic material or metallic material. The plastic material can be selected from a group of materials consisting of ABS (Acrylonitrile-Butadiene-Styrene), PMMA (Polyethylmethacrylate), PC (Polycarbonate), and etc. The metallic material can be selected from a group of materials consisting of stainless steel, titanium alloy, aluminum alloy, and etc. The base body 10 can also be electroplated with metallic material, e.g., chromium.

The color-changing layer 20 is configured to change color thereof according to changes of temperature thereof. The color-changing layer 20 is formed on a surface of the shell 100 by means of spraying or printing. During process of spraying, a compound of reversible thermosensitive color-changing materials, cohesive agents, solidified agents, and coupling agents is spayed on the surface of the shell 100. During printing process, reversible thermosensitive color-changing oil is printed on the surface of the shell 100. The reversible thermosensitive color-changing material can be organic material or liquid crystalline polymer material. The compound and the reversible thermosensitive color-changing oil is due to change colors in a temperature range from 0° C. to 39° C.

The protective layer 30 is formed on a surface of the color-changing layer 20. The protective layer 30 is used to protect the color-changing layer 20 from being damaged, e.g., scuffing. The protective layer 30 is colorless and transparent resin film, such as polycarbonate resin film and etc.

When the shell 100 is placed from an environment with a low temperature into another environment with a high temperature, the color of the shell 100 can subject to change. When the hand of a user touches the protective layer 30 of the shell 100, thermal energy is inducted through the protective layer 30 to the color-changing layer 20. The color-changing layer 20 therefore changes its color and changes the corresponding color of the shell 100. The shell 100 is placed proximate to a thermal source (e.g., a boiling stove). Similarly, the color of the shell 100 is correspondingly varied.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shell of an electronic device, comprising:
a base body; and
a color-changing layer formed on a surface of the base body and configured to change the color thereof according to changes of temperature thereof.

2. The shell of an electronic device as claimed in claim 1, wherein the color-changing layer comprises a compound of reversible thermosensitive color-changing materials, cohesive agents, solidified agents, and coupling agents.

3. The shell of an electronic device as claimed in claim 2, wherein the reversible thermosensitive color-changing material can be one of organic material and liquid crystalline polymer material.

4. The shell of an electronic device as claimed in claim 3, wherein the compound can change its color in a temperature range from 0° C. to 39° C.

5. The shell of an electronic device as claimed in claim 1, wherein the color-changing layer comprises reversible thermosensitive color-changing oil.

6. The shell of an electronic device as claimed in claim 5, wherein the reversible thermosensitive color-changing oil can change its color in a temperature range from 0° C. to 39° C.

7. The shell of an electronic device as claimed in claim 1, wherein the base body is made of plastic material or metallic material.

8. The shell of an electronic device as claimed in claim 1, wherein the base body is electroplated with metallic material.

9. The shell of an electronic device as claimed in claim 1, further comprising a protective layer formed on a surface of the color-changing layer.

10. The shell of an electronic device as claimed in claim 9, wherein the protective layer is colorless and transparent resin film.
